(19) United States
(12) Patent Application Publication
(10) Pub. No.: US 2016/0325689 A1
(43) Pub. Date: Nov. 10, 2016

(54) CUSTOM COLOR MATCHED TRANSPONDER RECEPTACLE

(71) Applicant: Mitchell Stein, Los Angeles, CA (US)

(72) Inventor: Mitchell Stein, Los Angeles, CA (US)

(21) Appl. No.: 14/705,910

(22) Filed: May 6, 2015

(51) Int. Cl. B60R 7/08; B60R 7/04

(52) U.S. Cl. CPC B60R 7/08; B60R 7/04

(57) ABSTRACT

In accordance with one embodiment, a receptacle for a mobile transponder device that will allow the transponder to be mounted inside a vehicle and conceal the transponder while permitting it to continue communication with toll receivers. An additional object is to provide a protective case for a mobile transponder device in which the leather on the onside of the case will be an exact match to the leather in a given vehicle preventing it from standing out for being incongruous with the rest of the vehicle's interior design.

### CROSS-REFERENCE TO RELATED APPLICATIONS

This application is a divisional, pursuant to 37 C.F.R. §1.53(b), of parent application Ser. No. 13/967,235 filed on Aug. 14, 2013 and entitled CUSTOM COLOR MATCHED TRANSPONDER RECEPTACLE and the benefit of such earlier filing dates is hereby asserted to pursuant to 35 U.S.C. §120.

### CROSS-REFERENCE TO RELATED APPLICATIONS

None.

### BACKGROUND

The following is a tabulation of some prior art that presently appears relevant:

U.S. Patents

| Pat. No. | Kind Code | Issue Date | Patentee |
|---|---|---|---|
| 4,165,554 | A | Aug. 28, 1979 | Faget |
| 4,951,817 | A | Aug. 28, 1990 | Barletta, et. al. |
| 5,333,768 | A | Aug. 2, 1994 | Krentz |
| 5,388,691 | A | Feb. 14, 1995 | White |
| 6,982,108 | B2 | Jan. 3, 2006 | Janssen et al. |
| 8,295,896 | B2 | Oct. 23, 2012 | Jeon |
| 8,380,264 | B2 | Feb. 19, 2013 | Hung et. al. |

U.S. Patent Application Publications

| | | | |
|---|---|---|---|
| Publication Number | Kind Code | Publ. Date | Applicant |

[symbol]

[symbol]

indicates data missing or illegible when filed

### Foreign Patent Document

None found

### Nonpatent Literature Documents

None found

### GOVERNMENT CONTRACT

Not applicable.

### STATEMENT RE. FEDERALLY SPONSORED RESEARCH/DEVELOPMENT

Not applicable.

### NOTICE OF COPYRIGHT AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### DISCUSSION OF THE RELATED ART

Protective cases for lane-based and open road toll collection transmitters have been proposed in the art and are commonly known to be made from flexible materials such as leather as well as synthetic materials meant to resemble leather or vinyl on automobile dashboards. Vehicle transponders are well known for having to be attached somewhere within the vehicle in order to communicate pertinent information to a receiver at a toll passing whenever the transponder passes by. However, they can detract from the appearance of the vehicle interior because their appearance is incongruous with the automakers original design.

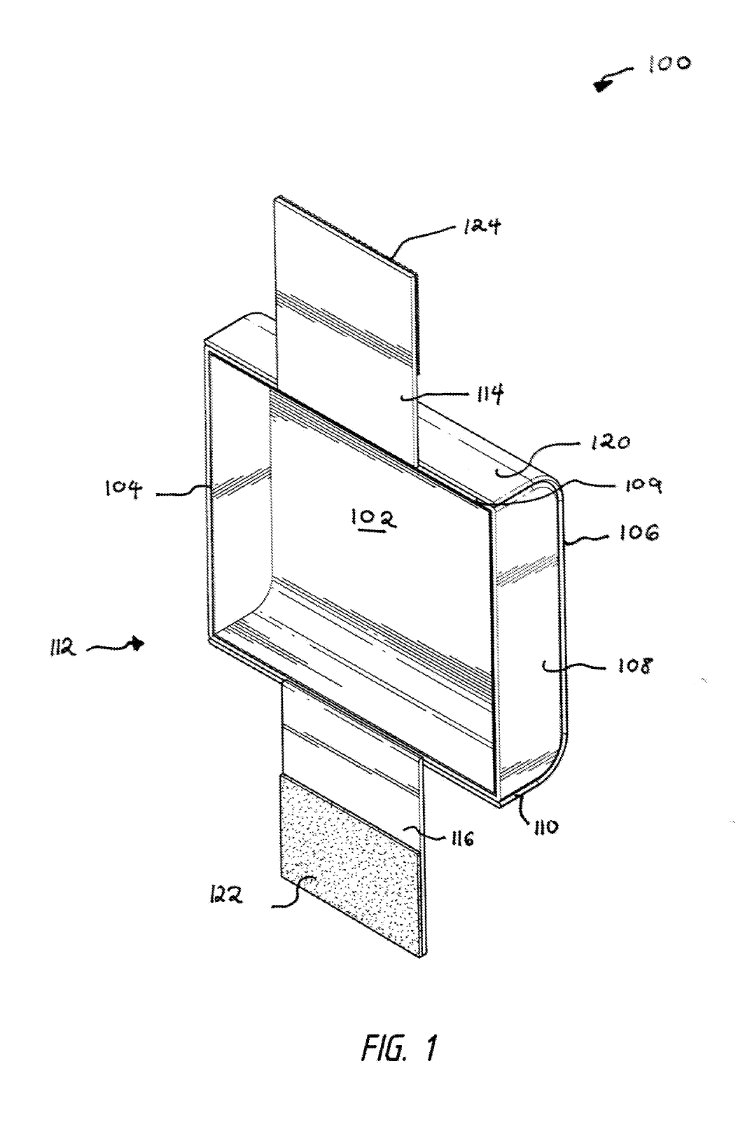

U.S. Pat. No. 4,951,817 shows a receptacle case 18 FIG. 1 formed out of protective material, such as leather, vinyl, or cloth which is used for protecting electronic beeper buttons.

Protective covers have also been used for other hand-held devices such as calculators. As an example, U.S. Pat. No. 4,165,554 discloses an assembly comprising a calculator with buttons on one side and a sliding cover which can be attached either to the front or the back. However, there is no leather or vinyl cover for this container and the container is not made to match the interior dashboard of a vehicle where it may be installed. Further, there are no modifications for using this cover with a wireless toll transponder.

No receptacle for such a transponder comprising a custom leather and vinyl exterior designed as an exact match to the interior of a vehicle is heretofore known. Specifically, custom cases especially directed toward protecting transponder devices commonly used for communicating with toll machines are not known in the art.

In the luxury automobile market, consumers pay a premium for an interior design aesthetic that suits their taste. Connecting the transponder directly to the vehicle interior can be unsightly and undesirable for those wishing to maintain the appearance of their vehicle interiors. Depending on where they live and how they commute, these individuals may be forced to adorn the interior of their cars with unattractive mobile transponder devices that allow them to pay for toll roads without stopping their vehicles to pay the toll at a toll booth. This can be a nuisance for those who value aesthetics enough to pay a premium on the cars they drive. It is accordingly an object of the instant invention to provide a protective case with a leather or vinyl covering to match the interior of such a vehicle while protecting a transponder therein and allowing it to be coupled with the interior of the vehicle.

Even though protective cases have been proposed in the past, all of the those heretofore known suffer from a number of disadvantages:
(a) the known cases are not designed to transmit to wireless toll transponders;
(b) the known cases are not designed for the various transponders found in different cities and states without interfering with their transmission capabilities;
(c) the known cases do not match the exact interior color of the vehicle they are installed in; and
(d) the known cases do not remain securely in the position they are installed in even when used on harsh surfaces such as cobblestone roads or pot holes.

Various protective cases for isolating mobile electronic have been proposed. However, none of the foregoing combine the characteristics of the present invention. Therefore, there is a need for a custom color matched transponder receptacle designed to be inconspicuously installed within a vehicle, without interfering with the transponders transmission capabilities, and that may be used for all of the various transponders in different geographic locations. The present invention effectuates these needs.

### SUMMARY

The invention relates to an improved case which may be coupled to the interior of a motor vehicle for protecting mobile toll transponders and switches from being damaged, all while matching the leather or vinyl within that vehicle so as not be be visually displeasing when installed in a luxury automobile.

A primary object of the present invention is to provide a protective case for a mobile transponder device capable of communicating with toll receivers such as EZ-Pass®, FasTrak®, Florida SunPass®, FasTrak® Orange County, and I-Pass® that will overcome the shortcomings of the prior art.

Another object is to provide a protective case for a mobile transponder device that will allow the transponder to be mounted inside a vehicle and that will conceal said transponder all while permitting it to continue communication with toll receivers outside the vehicle.

An additional object is to provide a protective case for a mobile transponder device in which the leather or vinyl on the outside of the case will be an exact match to the leather or vinyl on the dashboard of a given vehicle to prevent it from being conspicuous and making the interior of the vehicle appear unsightly.

A further object is to provide a protective case for a mobile transponder device that is simple and easy to use.

Further objects of the invention will appear as the description proceeds. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### Objects

It is therefore an object of the present invention to provide a custom color matched transponder receptacle as a “pop-in” case that can easily fit a wide variety of different mobile toll transponder devices.

It is a further object of the present invention to provide a transponder case which matches the interior fabric, leather or vinyl and color of the vehicle is installed in.

Finally, it is an object of the present invention to provide a transponder receptacle that may be quickly and easily installed in any vehicle while being so discrete so as to make it unnoticeable when installed. Such a receptacle may fit different cars and different transponders while keeping itself and its contents secure even while the vehicle is being driven on uneven surfaces.

These and other objects, features, and advantages of the present invention will become apparent in the following detailed description of the present embodiment thereof when read in conjunction with the accompanying drawings wherein the same reference numerals denote like or similar parts throughout the several views.

Although the description that follows contains many specificities, these should not be construed as limiting the scope of the embodiments but as merely providing illustrations of some of several embodiments. Thus the scope of the embodiments should be determined by the claims that are appended and their legal equivalents, rather than by the examples given. Those skilled in the art to which this invention pertains will be able to devise other forms thereof within the ambit of the appended claims.

### DESCRIPTION OF THE DRAWINGS

### Figures

FIG. 1 is a perspective view of the EZ-Pass embodiment of the present invention;

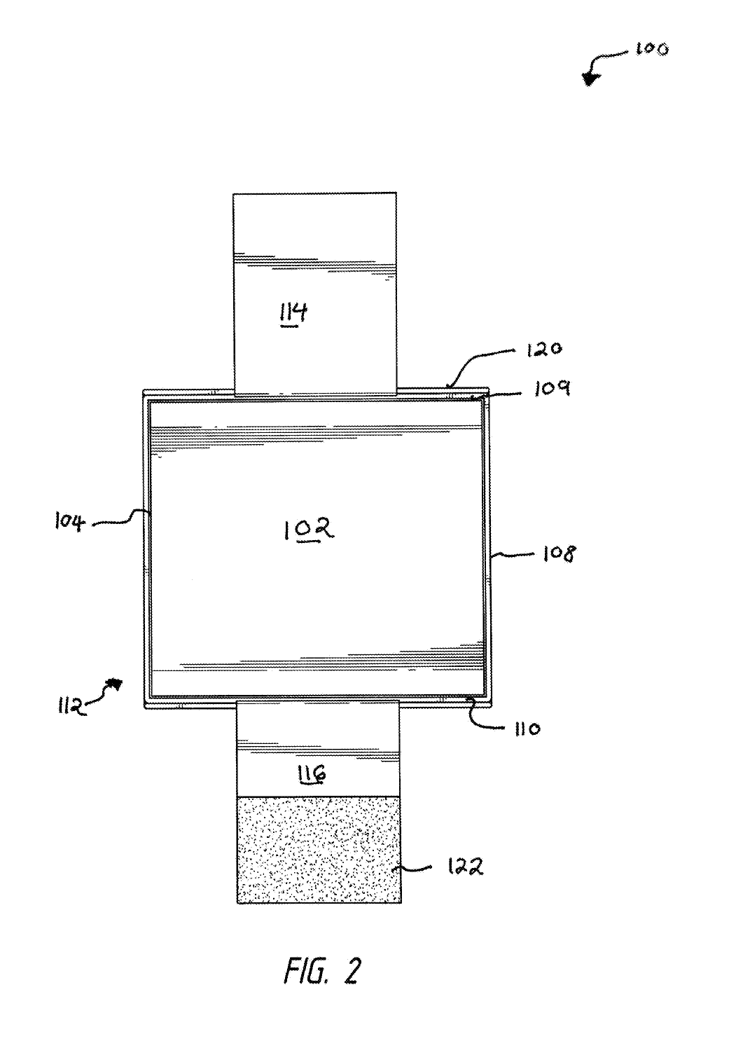

FIG. 2 is a back front view of the same apparatus as in FIG. 1;

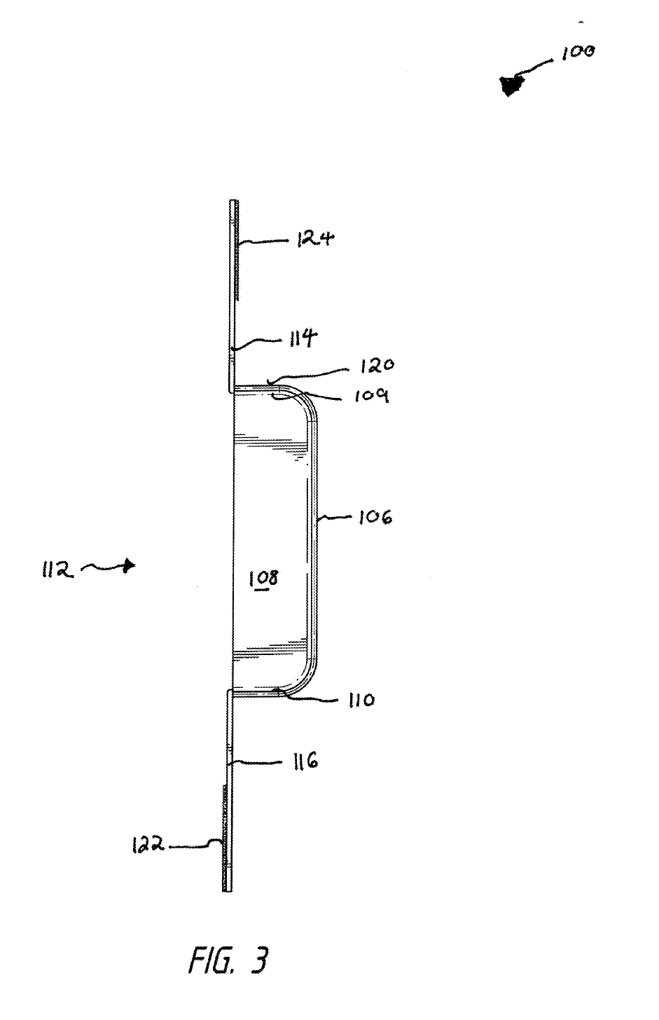

FIG. 3 is a right side view of the same apparatus as in FIG. 1;

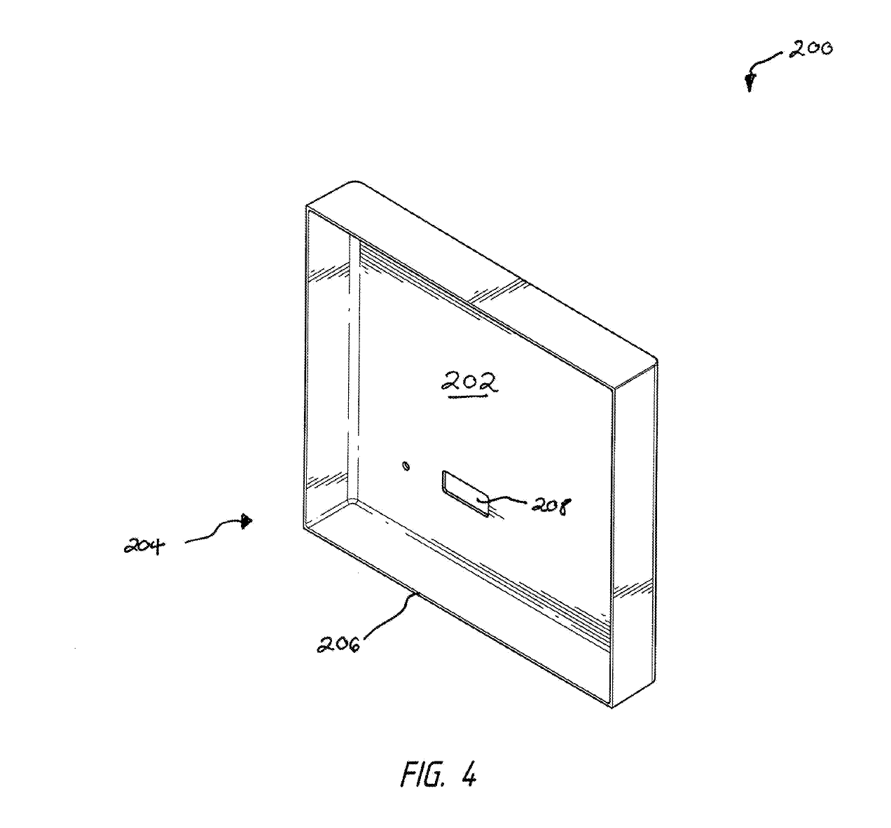

FIG. 4 is a perspective view of the FasTrak embodiment of the present invention;

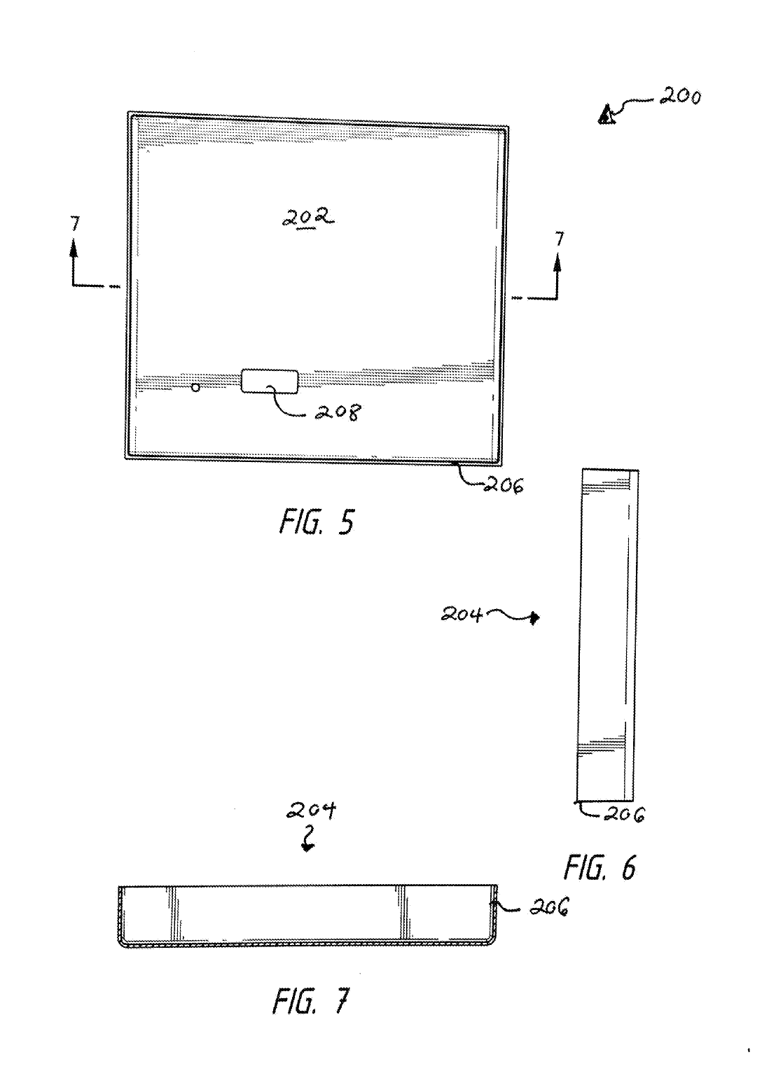

FIG. 5 is a back view of the same apparatus as in FIG. 4;

FIG. 6 is a side view of the same apparatus as in FIG. 4;

FIG. 7 is a second side view of the same apparatus as in FIG. 4;

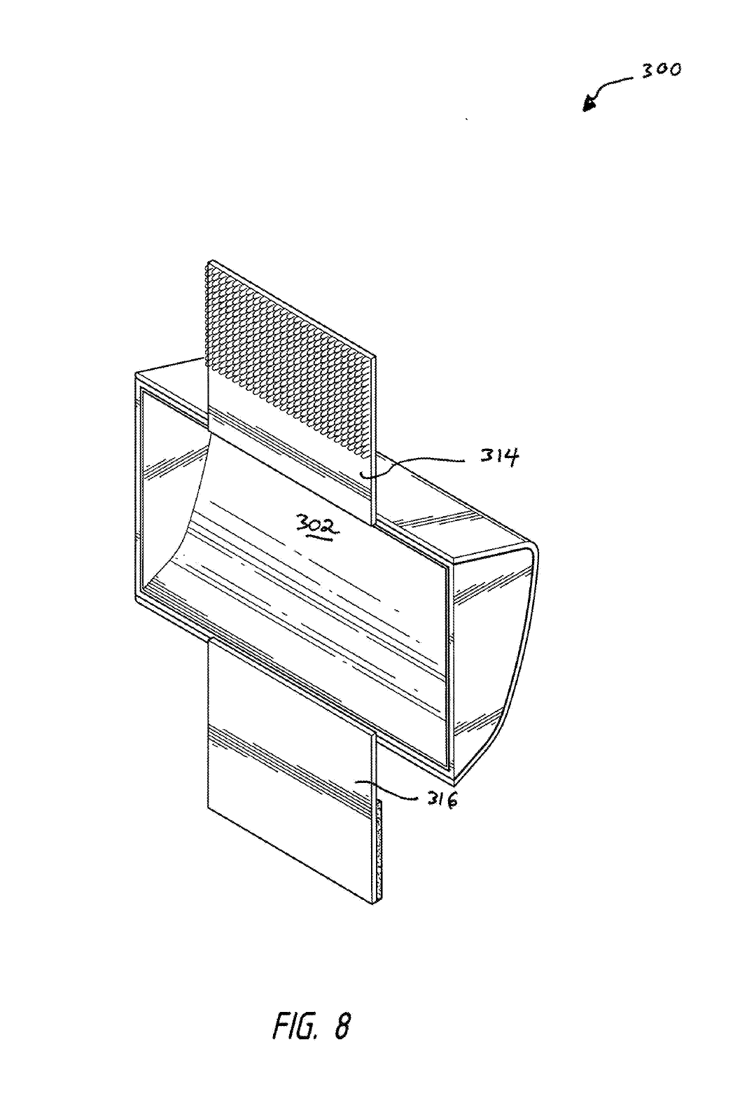

FIG. 8 is a perspective view of the I-Pass embodiment of the present invention;

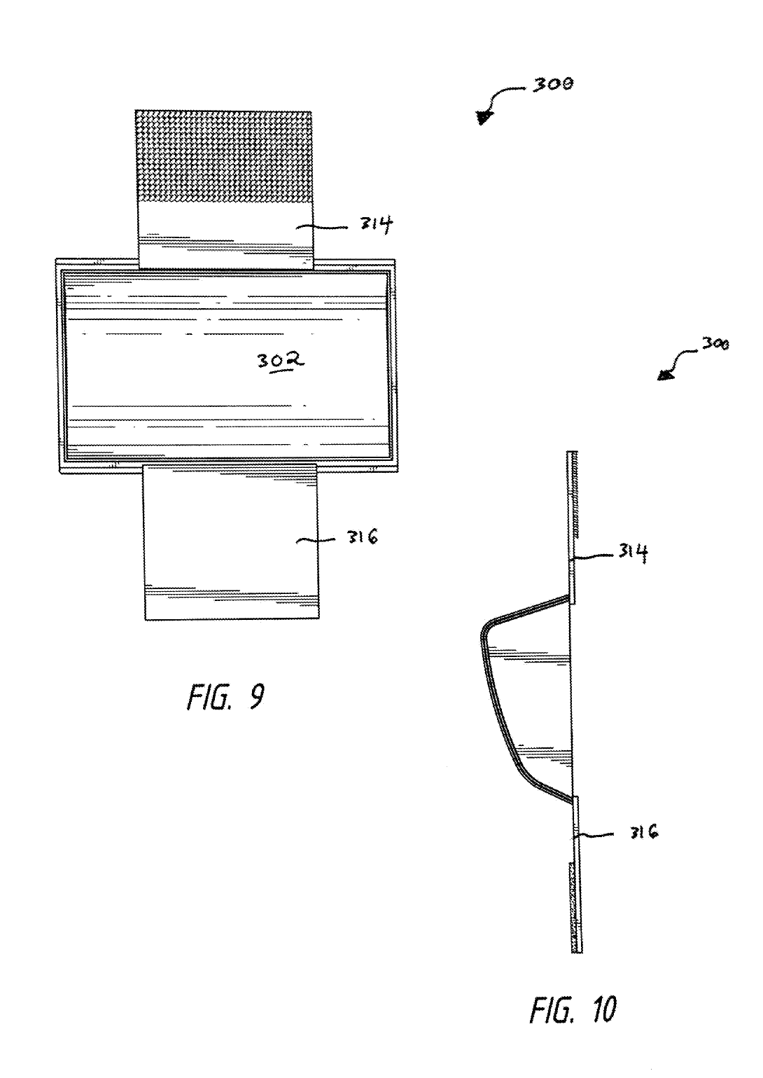

FIG. 9 is a front view of the same apparatus as in FIG. 8;

FIG. 10 is a side view of the same apparatus as in FIG. 8;

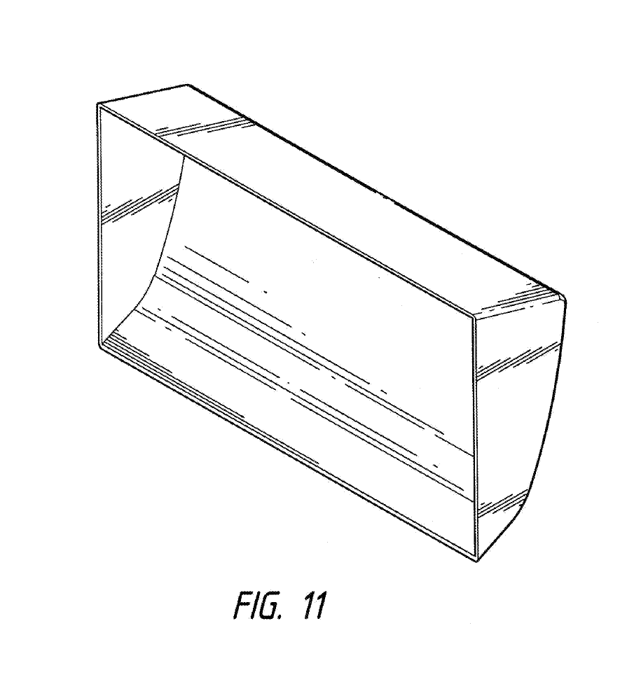

FIG. 11 is a perspective view of the I-Pass assembly of the present invention;

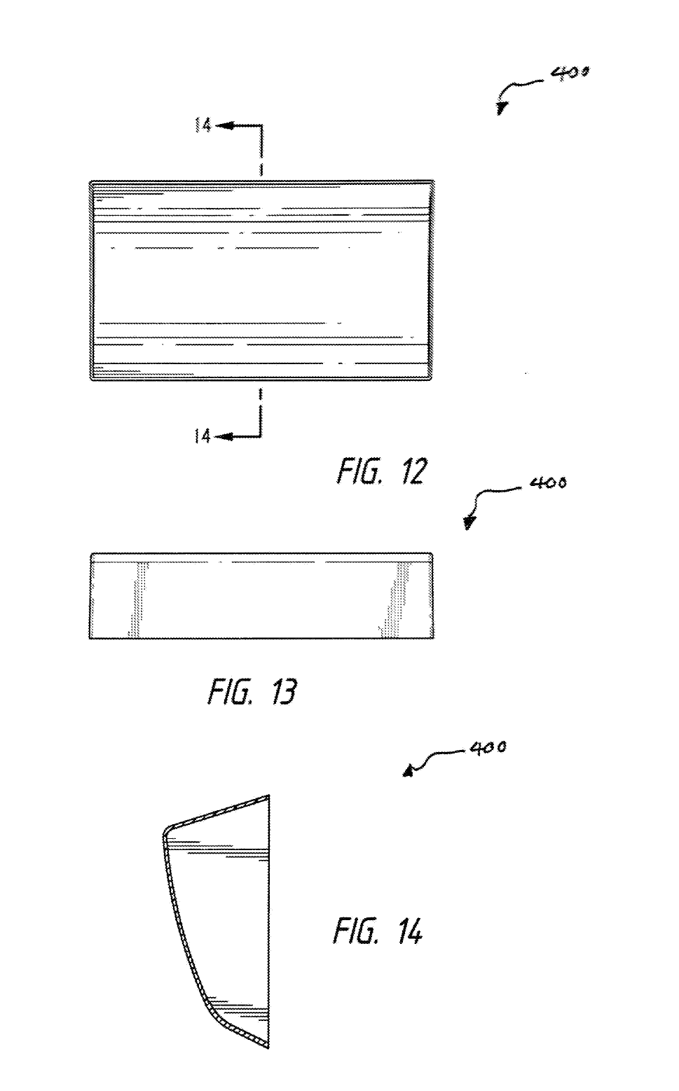

FIG. 12 is a back view of the same apparatus as in FIG. 11;

FIG. 13 is a side view of the same apparatus as in FIG. 11; and

FIG. 14 is a second side view of the same apparatus as in FIG. 11.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms“left,” “right,” “front,” “back,” “top,” “bottom,” “over,” “under,” and the like in the description and in the claims, if any, are used for descriptive purposes and not necessarily for describing permanent relative positions, it is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may he for any length of time, e.g., permanent or semi-permanent or only for an instant.

### DETAILED DESCRIPTION

Illustrative embodiments of the invention are described below. The showings are for purposes of illustrating preferred embodiments and not for purposes of limiting the same. The following explanation provides specific details for a thorough understanding of an enabling description for these embodiments. One skilled in the art will understand that the invention may be practiced without such details.

FIGS. 1, 2, and 3 illustrates a perspective view of the EZ-Pass embodiment of the receptacle of the present invention for a mobile electronic transponder which is merely exemplary and is not limited to the various toll road transponder devices disclosed herein. Here, the receptacle 100 includes a body 102 sized to contain a mobile toll road transponder device therein formed out of rigid protective material, such as leather, vinyl, paper, cloth, etc. and has a front wall 104, a rear well 106, a pair of side walls 108, a top wall 109, bottom wall 110 and an open top 112 for closely receiving the transponder device (not shown) therewithin. Said top 112 configured to allow visual and tactile access to the transponder device when the transponder device is in the cavity. A pair of securing straps 114 & 116 extend across the opening 112. Each originates from either the top wall 109 or bottom wall 110. The distal end of each strap comprises a means of connecting one strap to another. In one embodiment these may be either the hook 122 or the loop 124 surface of well known hook-and-loop fasteners.

In the same or different embodiments, the transponder case body 102 can be composed of leather, PVC, TPU, plastic, paper, nylon, neoprene, silicone, polyester, recycled plastic, vinyl, rubber, metal, synthetic leather and wool/synthetic felt, PLA, and/or paper. In still other embodiments, portions of the transponder case body 102 can be composed of one or more of the aforementioned materials while other portions of the transponder case body 102 can include one or more other aforementioned materials.

In order to protect the transponder device from damage while holding said device securely in place, the interior of the body 102 may be lined with a soft fabric. In one embodiment said fabric may be felt. Moreover, the pair of securing straps 114 & 116 are preferably made of leather. The straps may be fully lined or partially lined with any material including, but not limited to leather from any animal hide usable for leather, including but not limited to cowhide, kangaroo, bison, pigskin, deer-hide, alligator, and the like; natural fibers, including wool, cotton, rayon, silk, bamboo, linen, rubber, latex and the like.

The exterior of the body 120 is covered in specific leather selected to match the interior of the vehicle (not shown) it is to be installed in. The leather body cover is chosen from a variety of options which include the manufacturer color code provided by a particular automaker. By way of example and not limitation, Ford, Lincoln, and Mercury offer their vehicles with a variety of different interior color selections each with a corresponding color code (For example: Dark Tan 709, Light Cream 2224, Smoke 6110, and Currant 6425).

First, color data is obtained about the interior of the vehicle that the receptacle 100 is to be installed in. The color of the leather covering for the exterior body 120 is then selected to match that color. Once installed, the receptacle 100 will be indistinguishable from the surface it is attached to and does not detract from the aesthetic of the vehicle interior. The body 120 may be covered in different colors, patterns, textures and designs or a combination thereof. The fabric or material may be printed, embossed, embroidered, appliqued, painted, photo transferred and/or decorated or ornamented in any other way.

As particularly shown FIGS. 1, 2, and 3, a pair of securing straps comprising first securing strap 114, and second securing strap 116 which are coupled to the body 102 and folded against the top opening 112 in an overlapping relationship to, at least partially, close said opening. Straps 114 & 116 attached to one another by a first releasable fastener means. for purposes of illustration comprises a first hook and loop fastener having a first hook 122 and loop 124 VELCRO fastener. The hook 122 that is suitably attached to the outer surface of one strap 116 and a second, mating loop 124 VELCRO to the other strap 114 suitably attached to the overlapping inner surface of flap. That way, the pair of straps 114 & 116 serve to contain the transponder device securely inside the body 102 even when the user is engaged in driving on uneven surfaces encountering gravel, potholes, and the like.

The straps 114 & 116 may be preferably made of leather to match the exterior of the receptacle 100. In some examples, strap 114 & 116 can be composed of (or at least partially composed of) leather, PVC (polyvinyl chloride), TPU (thermoplastic polyurethane), plastic, nylon, neoprene silicone, polyester, recycled plastic, rubber, metal, wovens, knits. synthetic leather and wool/synthetic felt, and/or PLA (polyactide).

It is further envisioned that various other means of connecting the straps 114 & 116 may also be used. By way of example, and not limitation, such means include but are not limited to a snap fastener, buttons, magnets, or snap string ties as a mode for connecting straps 114 & 116 to one another and holding the transponder device securely inside the receptacle 100.

In one embodiment of said securings straps, at least one strap may comprise an opening to facilitate insertion of a suction cup through said strap. Said suction cup must be able to pass through the exterior of said strap and be removably attached to a transponder within the receptacle 100. Said opening (not shown) is preferably circular but may be any shape to accommodate the installation of at least one suction cup.

Another exemplary receptacle 200 is shown in FIG. 4-7. These figures illustrate a the FasTrak embodiment of the receptacle 200 of the present invention for a mobile electronic transponder. These figures include a different body 202 while retaining features such as the color matched interior designed to compliment the interior of the vehicle it is installed in, the felt lining, material composition, and elements numbered as in FIG. 1-3 perform in a substantially similar way.

In some embodiments, transponder receptacle body 202 forms mobile toll transponder cavity 204. Transponder device enclosure 204 includes transponder device opening 206 along the ends (e.g., the bottom) of transponder device enclosure 204. This opening allows the mobile transponder device (not shown) to be placed into and removed from the sponder device cavity 204. Furthermore, in some embodiments, transponder device opening 206 is configured to be closable and can be closed and secured by securing straps 114 & 116 such as those illustrated in FIG. 1.

In some counties, FasTrak toll transponder devices (not shown) typically include a switch that allows users to communicate information about the number of passengers in their vehicles wirelessly and to the toll receiver without stopping their vehicles to pay the toll at the toll booth. The FasTrak embodiment of the receptacle 200 additionally includes a passenger switch well opening 208 thereby allowing the mobile toll transponder device to function (i.e., the opening provides a hole for the switch of the transponder to peek out of the transponder receptacle 200).

FIGS. 8-14 illustrate multiple views of an embodiment of custom color matched transponder receptacle 300 designed for compatibility with I-Pass wireless toll transponder device. FIG. 8 is a front perspective view illustrating the receptacle 300 with securing straps 314 & 316. In FIG. 8-10, the securing straps 314 & 316 are in a non-deployed state. The receptacle 300 here displayed does not contain the I-Pass mobile transponder device which is a curvilinear shape matching the shape of the receptacle body 302.

FIG. 9 is front perspective view illustrating the transponder receptacle 300. In FIG. 9, the securing straps 314 & 316 are also in a non-deployed position. FIG. 10 is a left-side view illustrating the transponder receptacle 300. For clarity, the receptacle 300 is again displayed without the I-Pass mobile transponder device.

FIG. 11 is a front perspective view further illustrating the curvilinear shape of the transponder receptacle 400, In FIG. 11-14, the securing straps 314 & 316 are not shown to illustrate that in some embodiments of the custom color matched transponder receptacle 400, it is possible to execute the invention without said straps 314 & 316.

FIG. 12-14 illustrates additional views of an embodiment of the transponder receptacle 400. FIG. 12 is a back view of the receptacle 400. FIGS. 13 & 14 are side views of the receptacle 400 while laying Out on a surface and a right side view of the receptacle respectively.

Although the invention has been described with reference to specific embodiments, it will be understood by those skilled in the art that various changes may be made without departing from the scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the devices and method discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents

### CONCLUSIONS, RAMIFICATIONS, AND SCOPE

While a particular form of the invention has been illustrated and described, it will be apparent that various modifications can be made without departing from the spirit and scope of the invention. For example, the custom color matched transponder receptacle is illustrated in EZ-Pass®, FasTrak®, and I-Pass® embodiments even though the inventor contemplates the possibility that the apparatus may be modified to suit a variety of different mobile transponder devices in various counties all the while comprising the properties of the invention. Accordingly, is not intended that the invention be limited, except as by the appended claims.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Particular terminology used when describing certain features or aspects of the invention should not be taken to imply that the terminology is being refined herein to be restricted to any specific characteristics, features, or aspects of the transponder receptacle with which that terminology is associated. In general, the terms used in the following claims should not be constructed to limit the transponder receptacle to the specific embodiments disclosed in the specification, unless the above description section explicitly define such terms. Accordingly, the actual scope encompasses not only the disclosed embodiments, but also all equivalent ways of practicing or implementing the disclosed receptacle. The above description of embodiments of the transponder receptacle is not intended to be exhaustive or limited to the precise form disclosed above or to a particular field of usage. While specific embodiments of, and examples for, the transponder receptacle are described above for illustrative purposes, various equivalent modifications are possible which those skilled in the relevant art will recognize.

While certain aspects of the transponder receptacle are presented below in particular claim forms, the inventor contemplates the various aspects of the custom color matched transponder receptacle in any number of claim forms. Accordingly, the inventor reserves the right to add additional claims after filing the application to pursue such additional claim forms for other aspects of the transponder receptacle.

What is claimed is:

1. A receptacle adapted to receive a portable transponder device of the type having a means to be removably attached to a vehicle attached thereto, said receptacle comprising:
a) a receptacle having interconnected walls comprising spaced front and rear walls, a pair of spaced side walls, a top wall and a bottom opening adapted for closely receiving a portable transponder device therewithin;
b) said rear wall having a cutout extending down from said top opening;
c) a band extending across said opening whereby portable transponder device can project its signal through said receptacle without interference while remaining inside said receptacle;
d) a cover completely covering the outside of said receptacle;
e) the color of said cover to be selected from a color database wherein the color database comprise a color identification code selected from a color code of a vehicle, a vehicle identification number (VIN) of the vehicle, a part of the VIN, or a combination thereof;
f) wherein said matching colors have color characteristics that match the interior color data and appearance characteristics that match the appearance data of the vehicle in which the receptacle is installed;
g) a fastener for securing said receptacle to said vehicle so that the transponder device can be placed within said receptacle remaining securely in place and blending in with the interior of the vehicle while allowing transponder information to be emitted from the transponder device without interference.

2. The receptacle of claim 1 where said band is comprised of two pieces connected using a hook and loop fastener.

3. The receptacle of claim 2 wherein said band is made of leather.

4. The receptacle of claim 1 wherein the interior of said receptacle is lined in felt.

5. A mobile toll road transponder device case, the mobile media device case comprising:
an enclosure with a cavity, the cavity sized to contain a mobile toll transponder device therein, the enclosure further having:
a top side;
a bottom side, the bottom side configured to receive the mobile toll transponder device;
a front side, the front side is configured to allow visual and tactile access to the mobile toll transponder device when the mobile toll transponder device is in the cavity; and
a back side, the back side having:
a first case back layer configured to be in mechanical communication with the top side and the bottom side of the enclosure wherein said case back colors have color characteristics that match the interior color data and appearance characteristics that match the appearance data of the vehicle in which the case is installed; and
a second case back layer including a securing strap opening; and
a securing strap having:
a first securing strap edge, the first securing strap edge elastically coupled between the first case back layer and the second case back layer;
a second securing strap edge, the second securing strap edge fixedly coupled between the first case back layer and the second case back layer;
a top surface located between the first positioning strap edge and the second positioning strap edge; and
a bottom surface opposite the top surface and located between the first positioning strap edge and the second positioning strap edge,
wherein:
two or more securing strap openings are located between an edge of the first case back layer of the back side and an edge of the second case back layer of the back side.
